(19) United States
(12) Patent Application Publication
(10) Pub. No.: US 2003/0110446 A1
(43) Pub. Date: Jun. 12, 2003

(54) Object class for facilitating conversion between Java and XML

(75) Inventor: Nicole A. Nemer, Superior, CO (US)

Correspondence Address: LAHIVE & COCKFIELD, 28 STATE STREET, BOSTON, MA, 02109, US

(73) Assignee: Sun Microsystems, Inc., Palo Alto, CA

(21) Appl. No.: 10/016,599

(22) Filed: Dec. 10, 2001

(51) Int. Cl. G06F 15/00

(52) U.S. Cl. 715/513

(57) ABSTRACT

A base object class is defined for conversion between Java and XML. The base object class may include a first method for converting from Java to XML. The base object class may also include a second method for converting from XML to Java. Object classes may then be defined that extend the base object class and that facilitate conversion between Java and XML.

### FIELD OF THE INVENTION

The present invention relates generally to computer programming and more particularly to an object class for facilitating conversion between Java and XML.

### BACKGROUND OF THE INVENTION

Java is a programming language that is object oriented and provides platform independence. (Java is a trademark of Sun Microsystems, Inc. in the United States and in other countries). As an object-oriented language, Java supports the notion of an “object class.” An object class describes a group of objects with similar properties, behavior, common relationships to other objects and, semantics. An “object” is an instance of an object class. Each object may encapsulate both methods and data.

The Extensible Markup Language (XML) is a markup language for documents containing structured information. Structured information contains both content and some indication of the role that the content plays. XML facilitates the specification of structures in a document. In particular, XML defines a standard way to add markup to documents. Like the Hyper Text Markup Language (HTML), XML employs tags. An example of a tag is “<home address>,” which designates that the data following the tag is home address information for a person. XML differs from HTML in that the tags are only used to delimit pieces of data. The interpretation given to the tags and to the data is left up to the application that processes the XML document.

XML and Java are both popular for use in network applications. For example, web pages and other kinds of content that are available via network applications may entail the use of both Java and XML. As such, it often may be desirable to convert between Java and XML. Unfortunately, developers currently are required to generate custom applications to perform this conversion. This approach is time-consuming, prone to error, and laborious.

### SUMMARY OF THE INVENTION

The present invention addresses the above-described limitations of conventional systems. In particular, the present invention provides a conveniently used mechanism for converting from Java to XML and then back from XML to Java. The mechanism is generalizable enough to support the conversion of many different varieties of Java objects into XML and many different varieties of XML structures into Java objects.

In an illustrative embodiment of the present invention, a base class is defined that includes conversion methods. A first conversion method converts Java into XML, and a second conversion method converts XML into Java. A selected object class may then be declared that is a subclass of the base class containing the conversion methods and that extends the base class. Thus, the conversion method merely needs to be invoked in order to perform the conversion of an object of the selected object class.

In accordance with one aspect of the present invention, a method is practiced in an electronic device. In accordance with this method, a base object class is provided that includes at least one method for converting between Java objects and XML data objects. A selected object class is provided that is a subclass of the base object class. For a given instance of the selected object class, the methods invoked perform the conversion of the given instance.

In accordance with an additional aspect of the present invention, a method is practiced in an electronic device where a base object class is provided. The base object class includes at least one method for converting Java objects and XML data objects. The first object class is defined as a sub-class of the base object class as is a second object class. The method for converting may be invoked for an instance of the first object class and/or an instance of the second object class. The method may convert a Java object in XML or conversely an XML document into Java.

### BRIEF DESCRIPTION OF THE DRAWINGS

An illustrative embodiment of the present invention will be described below relative to the following drawings FIG. 1 depicts the flow of conversion between Java and XML in the illustrative embodiment.

FIG. 2 is a block diagram of an electronic device suitable for practicing the illustrative embodiment.

FIG. 3 is a high-level flow chart of steps performed by the to XmlDoc( ) method.

FIG. 4 is a high-level flow chart of steps performed by the from XmlDoc( ) method.

FIG. 5 is a flow chart of steps performed in processing nodes in the from XmlDoc( ) method.

### DETAILED DESCRIPTION OF THE INVENTION

The illustrative embodiment of the present invention provides a base object class designated as “XmlBase.” The XmlBase object class contains methods for converting from Java to XML and then back from XML to Java. In order for an object to utilize the capabilities of the XmlBase object class, the object is defined to be of an object class that is a subclass of the XmlBase object class. The subclass extends the XmlBase object class. The methods for converting between Java and XML may then be executed on the object.

FIG. 1 is a block diagram that illustrates the conversion paths that are available between Java and XML in the illustrative embodiment of the present invention. A Java object 10 may be converted into XML 14 by invoking the to XmlDoc( ) method 12. This method, as will be described in more detail below, takes a Java object and converts the Java object into structured data in an XML document. The XML document 14 may then be converted back into a Java object 10 by invoking the from XmlDoc( ) method 16.

As was mentioned above, the Java object 10 is of an object class that is a subclass of the XmlBase object class. As such, the Java object inherits the methods of the XmlBase object class. These methods include the to XmlDoc( ) method 12 and the from XmlDoc( ) method 16. The object class of the object may be defined to extend the XmlBase object class. For example, suppose that an object is of object class A. In such a case, the object class definition for object class A might contain the statement “public class A extends XmlBase.”

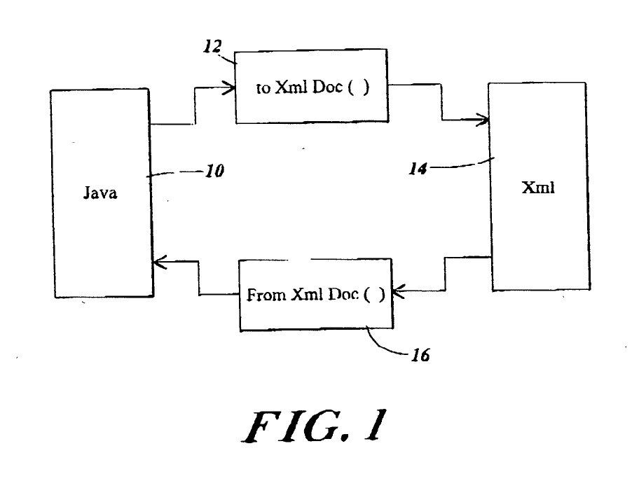

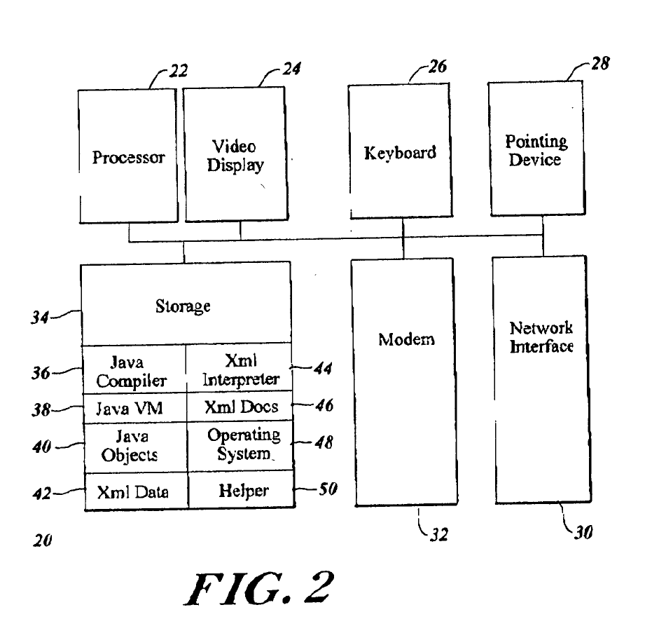

FIG. 2 shows a block diagram of an electronic device 20 that may be suitable for practicing the illustrative embodiment of the present invention. Those skilled in the art will appreciate that the electronic device 20 may take many forms including but not limited to a workstation, a personal computer, a network computer, an Internet appliance, a personal digital assistant (“PDA”), a mobile phone, an intelligent pager or another type of electronic device that is capable of understanding Java and XML. Those skilled in the art will also appreciate that the configuration shown in FIG. 2 is intended to be merely illustrative and not limiting of the present invention. The present invention may be practiced with different configurations that do not include all the peripheral devices depicted in FIG. 2.

The electronic device 20 of FIG. 2 includes a microprocessor 22. Those skilled in the art will appreciate that the electronic device 20 may in some embodiments include multiple microprocessors. The electronic device 20 further includes a video display 24, a keyboard 26 and a pointing device 28, such as a mouse. The electronic device 20 may include a network interface 30 for interfacing with a local area network (LAN) and a modem 32 for facilitating access to remote resources. The modem 32 may be of a variety of types, such as a wireless modem, a conventional telephone modem or a cable modem.

The electronic device 20 includes storage 34 that may include both primary memory and secondary memory. The storage 34 may include computer-readable media and may include removable media, such as a magnetic disk or an optical disk. The storage 34 holds a Java compiler 36 for compiling Java code into byte codes that may be executed by a Java virtual machine (VM) 38. The storage 34 may include a multitude of Java objects 40, including a definition for the XmlBase object class 42. The storage additionally includes an XML interpreter 44 and one or more XML documents 46. The storage may include an operating system 48, such as the Solaris operating system available from Sun Microsystems, Inc. Lastly, the storage 34 may include a helper section of code 50 that helps to parse XML and to perform other helpful functions.

An “interface” is a named set of logically related functions. An interface lists signatures, such as parameters and sets of methods. The interface does not provide code for implementing the functions; rather, the code for implementing the functions is provided by objects. An object that provides the code for implementing the functions of an interface is said to “support” the interface. The code provided by an object that supports an interface must comply with the signatures provided within the interface.

Java interfaces and classes may be grouped into packages. Sun Microsystems, Inc. has developed and made commercially available a number of different packages. These packages include but are not limited to the java.lang package that contains basic Java classes, the java.io package that provides classes to manage input and output streams and the java.util package that contains a number of utility classes. The illustrative embodiment will be described relative to an implementation wherein the XmlBase object class imports these packages.

The illustrative embodiment also utilizes “reflection” technology from Sun Microsystems, Inc. The reflection technology facilitates the interrogation of Java objects to obtain information regarding the objects, such as methods, fields and the like that are contained in the object.

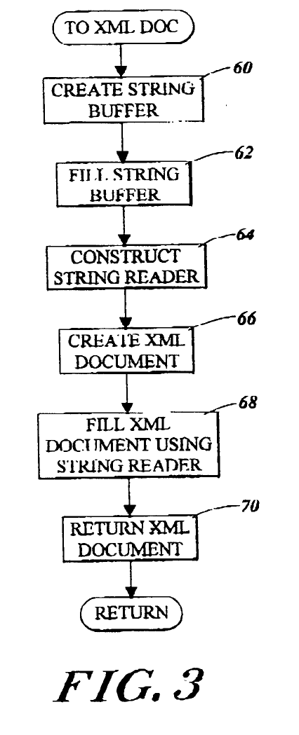

FIG. 3 is a flow chart illustrating at a high level the steps that are performed by the to XmlDoc( ) method in the illustrative embodiment. The method initially creates a StringBuffer object class (step 60 in FIG. 3). The StringBuffer object class is defined as part of the java.lang package and implements a mutable sequence of characters. More informally, it provides a buffer for holding strings. A StringBuffer may be created by calling a constructor method that is defined as part of the StringBuffer object class. By definition, the StringBuffer provides an append method that allows characters to be appended to the StringBuffer. The StringBuffer is used to hold characters from the Java object that is being converted and to hold tags and other information for creating a properly formatted XML document.

The to XmlDoc( ) method then fills the StringBuffer with the characters extracted from the Java object (step 62 in FIG. 3). In particular, the to XmlDoc( ) method parses the contents of the Java object to identify constituent components, such as methods, object classes, fields and the like. XML tags are inserted into the buffer at the appropriate locations so that proper structure is created. Tags to designate the beginning of the XML document and the end of the XML document are also inserted in sequence.

As was mentioned above, the to XmlDoc( ) method is applied on a per object basis. The processing initially obtains the object class of the Java object. An appropriate tag is provided to designate the object class in the XML document by adding the tag to the StringBuffer. Methods, fields, and other components in the object are then systematically and iteratively located by processing the object on a line per line basis. The reflection API contains methods for obtaining the name, type, arguments, and values of the components. These are used to extract the information that is added to the StringBuffer. Non-string values are converted into strings before being added to the StringBuffer. The appropriate tags are inserted where needed for each component. The tag is the name of the component.

A StringReader is then constructed (step 64 in FIG. 3). The StringReader is of the StringReader object class that is defined as part of the java.io package. The StringReader is an object that is a character stream whose source is a string. The StringReader is used to extract or “read” the data out of the StringBuffer.

An XML document is created by invoking the createXmlDocument( ) method (step 66 in FIG. 3). The java.lang package includes an XmlDocument object class. This object class includes the createXmlDocument( ) method that constructs an XML document from data in a specified input source. In the illustrative embodiment, the input source is specified as the StringReader that was created in step 64. Hence, in step 68 in FIG. 3, the XML document is filled using the StringReader. The resulting XML document is returned as the converted document holding the XML version of the Java object.

The createXmlDocument( ) method produces an XML document object of the XmlDocument object class. The XML document object class provides a document that complies with document object model (DOM). The DOM represents a document as a tree of nodes with each node containing a component for the XML structure. The nodes may contain elements (which are units of XML data delimited by tags) or text. The XmlDocument object class provides a static factory to create document instances and provides interfaces for traversing the tree. Instances represent the top level of an XML version 1.0 document.

The createXmlDocument( ) method creates an XmlDocument object that represents the XML document as a sequence of nodes, consistent with DOM. Thus, the input source to this method is parsed to build nodes as needed to complete the DOM representation.

The illustrative embodiment also imports the org.w3c.dom package. The package includes a document interface for representing an HTML or XML document. Among the methods specified in the interface in the getDocumentElement( ) method, which returns a document element property.

The org.w3c.dom package includes the node interface. The node interface is the primary data type for the entire document object model and represents a single node in a document tree. This interface specifies the getChildNodes( ) method. This method returns a node list that contains all the children of the node.

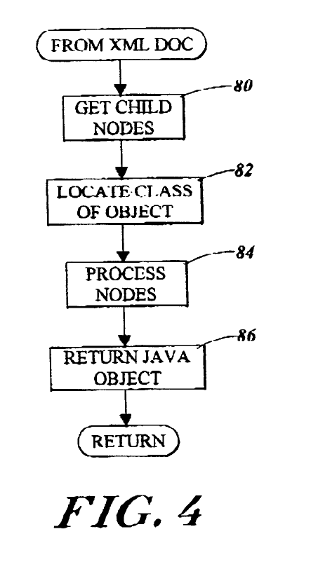

FIG. 4 provides a high-level flow chart of steps performed by the from XmlDoc( ) method. As was mentioned above, this method converts an XML document created by the to XmlDoc( ) method into a Java object. Initially, child nodes of the document root node in the XML document are obtained (step 80 in FIG. 4). It is likely that one of these child nodes holds information regarding the object class associated with the XML document. In the illustrative embodiment, it is presumed that the XML document was created by converting a Java object. Thus, in step 82, the class of the object is located. The nodes are then processed (step 84 in FIG. 4). In particular, the nodes on the node list that form the XML document are processed. The processing converts the nodes into an appropriate Java object. The resulting Java object that is created by processing all of the nodes is then returned (step 86 in FIG. 4).

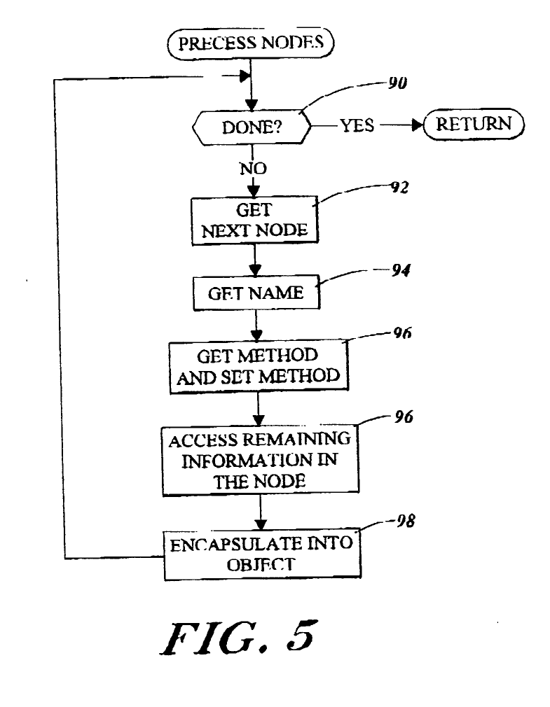

FIG. 5 provides a flow chart of how the nodes are processed at a high level. Initially, nodes are processed individually and a check may be determined whether there are any nodes left to be processed (step 90 in FIG. 5). If there are nodes left to processed the next node is obtained (step 92 in FIG. 5). The name of the node is accessed by extracting information from the tag that is provided for the node (step 94 in FIG. 5). A get method and a set method for setting the named node are then sought (step 96 in FIG. 5). This approach assumes that each object associated with the node has an associated get method and set method.

From the gathered information, the node is processed. In particular, the fields that are located within the node are identified and converted into the appropriate Java statements. Other methods and objects are also processed to determine their type and develop the appropriate Java syntax. All of this information is encapsulated into an object that is available and eventually encapsulated into the Java object that is returned by from XmlDoc( ) (step 98 in FIG. 5).

The from XmlDoc( ) method exploits the XML document complying with DOM. In particular, the method walks the node list and processes nodes individually. The helper code 50 may be used to parse XML tags and other content. The method identifies the type of information contained in the node and creates the appropriate Java statement. The objects associated with a node may be of many different data types and these data types are identified.

While the present invention has been described with reference to an illustrative embodiment thereof, those skilled in the art will appreciate that various changes in form and detail may be made without departing from the intended scope of the present invention as defined in the appended claims.

1. In an electronic device, a method, comprising the steps of:
providing a base object class that includes at least one method for converting between Java objects and XML data objects;
providing a selected object class that is a sub-class of the base object class; and
for a given instance of the selected object class, invoking the method to perform a conversion on the given instance.

2. The method of claim 1, wherein the selected object class is a Java object class.

3. The method of claim 1, wherein the selected object class is an XML data object class.

4. The method of claim 1, wherein the method for converting is invoked to convert a Java object into at least one XML data object.

5. The method of claim 1, wherein the method for converting is invoked to convert an XML data object into Java.

6. The method of claim 1, wherein the method for converting is invoked to convert an entire XML document into Java.

7. The method of claim 1, wherein the electronic device is a computer system.

8. The method of claim 1, wherein the base object class includes both a method for converting from Java to XML and a method for converting from XML to Java.

9. A medium for use in an electronic device, said medium holding instructions for performing a method, comprising the steps of:
providing a base object class that includes at least one method for converting between Java objects and XML data objects;
providing a selected object class that is a sub-class of the base object class; and
for a given instance of the selected object class, invoking the method to perform a conversion on the given instance.

10. The medium of claim 9, wherein the selected object class is a Java object class.

11. The medium of claim 9, wherein the selected object class is an XML data object class.

12. The medium of claim 9, wherein the method for converting is invoked to convert a Java object into at least one XML data object.

13. The medium of claim 9, wherein the method for converting is invoked to convert an XML data object into Java.

14. The medium of claim 9, wherein the method for converting is invoked to convert an entire XML document into Java.

15. The medium of claim 9, wherein the base object class includes both a method for converting from Java to XML and a method for converting from XML to Java.

16. In an electronic device, a method, comprising the steps of:
providing a base object class that includes at least one method for converting between Java objects and XML data objects;
defining a first object class as a sub-class of the base object class; and
defining a second object class as a sub-class of the base object class.

17. The method of claim 16, further comprising the step of, for an instance of the first object class, invoking the method for converting to perform conversion of the instance of the first object class.

18. The method of claim 17, further comprising the step of, for an instance of the second object class, invoking the method for converting to perform conversion of the instance of the second object class.

19. The method of claim 16, wherein the method for converting converts a Java object into XML.

20. he method of claim 16, wherein the method for converting converts an XML document into Java.
